(19) United States
(12) Patent Application Publication
(10) Pub. No.: US 2013/0288230 A1
(43) Pub. Date: Oct. 31, 2013

(54) Method for identification of a natural biopolymer

(71) Applicants: Artur Martynov, Kharkov (UA); Boris S. Farber, Brooklyn, NY (US); Sonya Sophya Farber, New York, NY (US)

(72) Inventors: Artur Martynov, Kharkov (UA); Boris S. Farber, Brooklyn, NY (US); Sonya Sophya Farber, New York, NY (US)

(21) Appl. No.: 13/849,883

(22) Filed: Mar. 25, 2013

Related U.S. Application Data
(63) Continuation-in-part of application No. 12/931,459, filed on Feb. 1, 2011, now abandoned.
Application No. 12/931,459 is a continuation of application No. PCT/RU2010/000689, filed on Nov. 22, 2010.

(51) Int. Cl. G01N 21/64

(52) U.S. Cl. CPC G01N 21/6486
USPC 435/5; 435/19; 435/6.1; 435/23

(57) ABSTRACT

The invention presents a method of identifying natural biopolymer—a protein, DNA, RNA in biological fluids and environmental objects, which is based only on the structure of the biopolymer and does not require pathogen genome sequencing, or animals vaccination by biopolymer-antigen. For this purpose the biopolymer itself is taken—a protein, DNA, or RNA, that is fragmented with enzyme to oligomer fragments—a mixture of oligopeptides, oligonucleotides DNA mixture, mixture of RNA oligonucleotides, without dividing the mixture into individual components, then carboxylation of structure in oligomer components is performed by acylation or alkylation.

### CROSS REFERENCE TO RELATED APPLICATIONS

The present application is a continuation-in-part of the application Ser. No. 12/931,459, filed Feb. 1, 2011, which is a continuation of the International Application No. PCT/RU2010/000689, filed Nov. 22, 2010.

### TECHNICAL FIELD

This invention relates to medicine and pharmaceuticals, specifically, to methods of design and synthesis of new drugs.

### BACKGROUND OF THE INVENTION

Immunochemical reaction—is the most common reaction in nature, allowing the two proteins interact specifically. Typically, a single protein is a target or antigen and a second protein is an antibody or a targeted molecule. Antibodies may have different specificity and nature. The same reaction of the antigen-antibody is used in the diagnosis of antigen detection of various diseases or in determining the concentration of a particular protein, such as insulin in patients with diabetes.

The reaction between the bivalent immunoglobulin G, which is most often used for diagnostic or therapeutic purposes, and the corresponding antigen is quantitative and allows to evaluate the concentration of a protein antigen in body fluids. The most common methods of identifying and establishing protein-antigen concentration are immuno-enzymatic method, immunofluorescence, immuno-chromatographic method, and immunodiffusion in agar, and electrophoresis method in gel and on paper.

Recently, a method of capillary gel electrophoresis in special bio-analyzers is often used. The main disadvantage of the immunochemical reaction is the need for specific purified antibodies: monoclonal antibodies are too specific to one epitope and stop working with a slight change in the protein antigen. And for the production of polyclonal antibodies, animal vaccination with source protein antigen is required, and then, for a lengthy time period, clearing of the resulting whey, isolation of antibodies from it, and finally, standardization of received immunoglobulin specificity and sensitivity.

Sometimes during epidemic outbreaks there is not enough time to study pathogens, it is needed to quickly develop a sensitive and specific test system for detection of the poorly known pathogen in the epidemic epicenter. Most suitable for this purposes are methods based on DNA hybridization. But in order to apply these methods it is necessary to conduct genome sequencing of the pathogen. This is quite a long process and can take several months. Accordingly, for the new and limitedly studied infectious diseases there are virtually no diagnostic methods that do not involve the use of immunoglobulin or do not require sequencing of the genome of the pathogen.

Terminology:

Natural biopolymers. Natural biopolymers are DNA, RNA, proteins that need to be identified for diagnostic purposes, for example, for identification of the causative agent of a disease via specific protein (or polynucleotide), or to determine the level of a specific protein in the blood. These specific biopolymers are produced by their preliminary treatment and extraction from detectable agent grown under cultivation, or obtained by synthesis (eg, recombinant method).

Identification of a natural biopolymer. Identification of a natural biopolymer means identification of specific proteins, DNA, RNA in biological fluids (urine, saliva, blood, cerebrospinal fluid, and various washings from the cavities of dead or living organisms), or in the environment—water, soil, food, using visualization methods of reaction products—gel electrophoresis, ELISA, immunofluorescence method, electrochemical method, method of chromatography on thin layers (similar to immunochromatography).

As a specific exposing reagent in this case there are used not immunoglobulins for detection of proteins and not DNA for the detection of DNA, but a mixture of carboxylated oligomers of the source biopolymer.

Enzymatic fragmentation. Enzymatic fragmentation of the natural biopolymer means: when natural biopolymer is protein, —treatment of detectable protein by proteolytic enzymes—trypsin, pepsin, papain, or other enzymes, followed by formation of a mixture of oligopeptide fragments. For the case, when natural biopolymer is DNA-treatment of DNA by deoxyribonucleases with formation of a mixture of oligo-deoxyribonucleosides. When natural biopolymer is RNA treatment of the original RNA by ribonucleases with formation of a mixture of oligo-ribonucleotides.

Carboxylation of the mixture of oligomer fragments. Carboxylation of the mixture of oligomer fragments obtained after fermentation of the initially diagnosed biopolymer targets, means treatment of this mixture by carboxylation agents through covalent modification reactions, such as acylation of polycarboxylic acids with anhydrides or alkylation of chlorine derivatives with monocarboxylic acids.

Reagent selectively binds. Reagent that binds selectively source biopolymer, represents the reagent which we use—a mixture of carboxylated oligomer fragments that replace specific immunoglobulin in test systems based on ELISA, IFA, electrophoresis, immunoelectrophoresis, or replace primer/amplicons in PCR, or in situ hybridization in case when the source detected biopolymer is DNA or RNA.

### SUMMARY OF THE INVENTION

The invention presents a method of identifying natural biopolymer—a protein, DNA, RNA in biological fluids and environmental objects, which is based only on the structure of the biopolymer and does not require pathogen genome sequencing, or animals vaccination with antigens of the pathogen. For this purpose the biopolymer itself is taken—a protein, DNA, or RNA, that is fragmented with enzyme to oligomer fragments—a mixture of oligopeptides, oligonucleotides DNA mixture, mixture of RNA oligonucleotides, without dividing the mixture into individual components, then carboxylation of structure in oligomer components is performed by acylation or alkylation.

In this case, the charge of lysine and histidine residues in proteins changes to the opposite, and in the structure of DNA and RNA purine bases carboxylate at accessible amino groups. This mixture has a high specificity for binding to the original biopolymer. When the original biopolymer is mixed with such mixture, layered supramolecular structures are formed between the mixture of carboxylated oligomers and the source of biopolymers, which are easily detected by changes in the molecular weight or by the formation of insoluble adducts.

These products of specific interaction are detected by gel electrophoresis, ELISA, immunofluorescence method, electrochemical method, method of chromatography on thin layers (similar to immunochromatography). The sensitivity of this method allows detection of 0.0045 mg/mL of the biopolymer (for example, the protein insulin) with absolute specificity. Specificity depends less on specific reaction of ion interaction than on the formation of complex multi-dimensional supramolecular structures, which are formed only in the presence of the target biopolymer, involving it in the assembly of such a structure.

Such structures are often not soluble in any solvent, for example, when using a mixture of carboxylated oligonucleotides of DNA or RNA, and the mass of the reaction products of diagnostic mixture of carboxylated oligomers with protein is much higher by a molecular weight than the original protein. Thus, with gel electrophoresis such product does not move out of the starting lunula and has the properties of high molecular weight colloid structure.

### BRIEF DESCRIPTION OF THE DRAWINGS

FIG. 1 shows the diagram of insulin enzymatic hydrolysis by pepsin, and places accessible to succinic anhydride attack.

FIG. 2 shows the voltage-current curves for insulin solution.

FIG. 3 shows the voltage-current curves without insulin solution.

FIG. 4 shows the dependence between fluorescence level and quantity of DNA in sample.

### EXAMPLE 1

### Selective Detection of Proteins. Insulin

For correct treatment of patients with diabetes is very important to determine the level of insulin in the blood in order to establish a correct diagnosis—is it the first- or second-type diabetes. The first type is characterized by the absence or by very low levels of insulin in the blood. To determine the level of insulin with or without glucose load the classical method of ELISA is used, where IgG are adsorbed on the tablet against human insulin. When the patient blood plasma is introduced to the tablet, insulin specifically reacts with antibodies at the tablet bottom, and after the tablet is cleaned, it remains adsorbed at the bottom of the tablet.

When anti-insulin IgG are added to the lunules as a conjugate with peroxydase, these specific antibodies also react with insulin and form a sandwich-type structure. After lunules are cleaned in the presence of insulin in whey, antibodies with peroxidase remain in lunula. Adding hydrogen peroxide and o-phenylenediamine in the lunula reflects in blue staining proportional to the amount of insulin. In the absence of insulin—no antibodies with peroxidase remain in lunula after washing and no staining appear in the lunula after hydrogen peroxide the dye are added.

Synthesis of MI on the basis of insulin's succinylated peptides. Crystalline insulin (Indar, Ukraine) in the amount of 100 mg was dissolved in 1 mL of 0.1 M hydrochloric acid and then enzymatically hydrolyzed by incubation with pepsin (Fluka, 400 ED/mg) at room temperature for 1 hour. Then, while stirring the solution the powdered succinic anhydride (7.5 mg) was added slowly and incubated with stirring for 60 minutes. The resulting peptides were purified of salts in column Sephadex G-25, with TRIS-hydrochloride as the eluent. The yield of protein was controlled by the absorption of the eluate in the UV region of the spectrum, at 280 nm. Salt-free peptides were poured into vials and lyophilized. Further the hypoglycemic effect of MI on the model of alloxan diabetes was studied in rats: at rest and during glucose load. Input control of insulin was provided using the microfluidic method at bioanalyzer Agilent-2100, chip Protein-80 [1]. MI was analyzed using high pressure liquid chromatograph at Millichrom-A-02 (Novosibirsk, Russian Federation) in the Microcolumn [2,3], Hypersil-18 at a pressure of 30 kPa 5% ACN, 50 mM ADHP to 60% ACN, 50 mM ADPH.

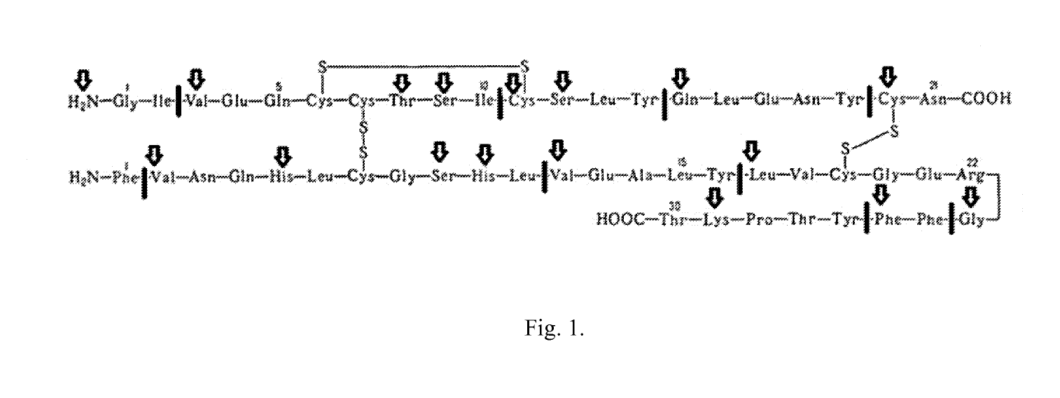

FIG. 1 shows the diagram of insulin enzymatic hydrolysis by pepsin, and places accessible to succinic anhydride attack. Black bars show places of insulin hydrolysis, when it is treated with pepsin: only seven peptides are produced, the amino groups that should be attacked by anhydride are shown by black arrows (the number of groups available for acylation-n=17).

Hydrolysis results in seven oligopeptides. Partial acylation of these peptides is calculated according to the laws of combinatorics to obtain the maximum number of peptide derivatives. The ratio of insulin moles that should be modified to moles of anhydride is calculated according to combinatorial equation [4]:

m=(2ⁿ−1), (1)
where:
m—number of molecules (and moles) of insulin, which must be modified to obtain the maximum amount of various insulin derivatives, this value for insulin is equal to 131,071.
n—number of amino acid residues available for modification by anhydride in one insulin molecule (it is conditionally accepted that insulin is not hydrolyzed, and represents the whole molecule).

$$k = \frac{n ( {2}^{n} - 1 ) + n}{2} = n {2}^{( n - 1 )} , \qquad ( 2 )$$

where:
k—number of moles of succinic anhydride, which is necessary for the modification of a protein molecule containing n groups available for modification.

In our case, n=17, k=1114112. Thus, for the modification of 131 071 mol of insulin, 1,114,112 mol of succinic anhydride are required. This results in 131 071 different molecules of succinylated insulin. The molar ratio of anhydride to insulin is 8.5:1. In this case, the synthesis will be observed of the maximum number of different insulin derivatives capable of interaction and self-organization into the supramolecular structure of quasi-insulin on the insulin receptor.

The chromatogram of the industrial insulin Indar separation was provided in bioanalyzer Agilent-2100 that operates on the microfluidic principle. Insulin was presented in the form of two isomers with similar molecular weights that is characteristic of microbial proteins with different folding pathways. This chromatogram confirms presence of insulin in the initial preparation in case of its relatively high purity, and allows yielding MI.

Next the HPLC chromatogram of the final MI product was provided, —namely, the mixture of acylated peptides after proteolysis of insulin by pepsin. As can been seen in the chromatogram, instead of the original seven peptides the significantly greater number of succinylated peptides is synthesized that confirms completion of the combinatorial synthesis reaction. This chromatogram can be further used as the primary method of quality control for the medicines based on quasi-living systems.

Providing the electrochemical test system based on quasi-living system of insulin. To visualize the reaction of formation of a complex between the selective hydrolysis products of insulin and insulin plasma, the graphene slide, size 0.3×0.3 mm, was used as the primary electrode, which was connected to two additional electrodes. Impedance was determined by the classical impedance spectrometer, type Solartron, Autolab, ZAHNER-elektrik GmbH, Gamry.

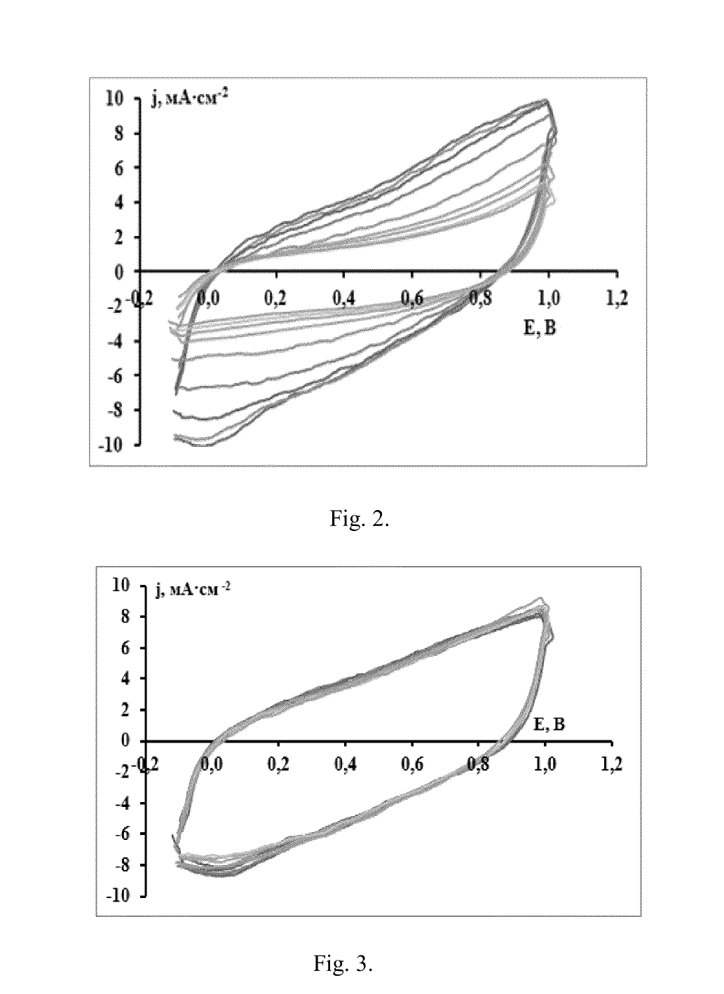

A drop of undiluted blood plasma and a drop of phosphate buffer containing 0.02 mg/ml (in terms of protein) of the mixture of carboxylated oligopeptides insulin (IR) were placed on a slide. The control slide received a drop of blood plasma of healthy person and 10-fold dilutions of insulin, also drop IR was added. The impedance was controlled—i.e., the current-voltage relationship. See FIG. 2: Voltage-current relationship between the concentration of insulin in human blood plasma (or of 10-fold dilutions of insulin with 0.04 mg/mL to 0.0000004 mg/mL) and the view of the impedance curve.

If instead of 10-fold dilutions of insulin or human blood to add 10-fold dilutions of albumin or other heterogeneous protein (we have taken thyroglobulin, lactalbumin, egg albumin) in the same concentration in mixture with carboxylated peptides of insulin, the following picture of impedance curve is observed, see FIG. 3: Voltage-current relationship between 10-fold dilutions of albumin with 0.04 mg/mL to 0.00004 g/mL and a view of the impedance curve.

As can be seen in the figures, the quantitative relationship between insulin concentration and peak height is observed only in the interaction of insulin with the IR. When the negative control of albumin or other protein is used, impedance curves overlap and coincide with the control curve. Thus, the reaction between carboxylated oligopeptides insulin—IR and insulin itself is quantitative and allows to indicate the level of insulin in the blood plasma. It is specific (reaction between albumin and IR is not observed).

### EXAMPLE 2

### Selective Detection of a Mixture of Proteins

Obtaining a test system for the diagnosis of influenza containing neuraminidase N1 and hemagglutinin H1.

Amniotic fluid is taken after the infection of a chicken embryo with the H1N1 influenza virus and its incubation until the aggregation of the maximum quantity of viruses in known standard conditions. The influenza virus contained therein is then purified according to known method and is concentrated through dialysis. To the concentrate obtained, a solution of trypsin is added so that the ratio of enzyme-protein is 1:100. This is left in an incubator at a temperature of 37° C. for 12 hours. The concentration of dissolved oligopeptides that are the products of hydrolysis was determined via spectrophotometer at 280 nm and 260 nm. The spectrophotometry method of protein determination is based on the ability of aromatic amino acids (tryptophan, tyrosine, and to a lesser extent, phenylalanine) to absorb ultraviolet light, with the maximum absorption at 280 nm.

It is conditionally acceptable to believe that at a protein concentration in the solution equal to 1 mg/mL, the optical density value at 280 nm is equal to 1 when cuvettes with a layer thickness of 10 mm are used. The drug's eluent was used in the capacity of a comparison solution. The concentration of the experimental protein in the solution must be from 0.05 to 2 mg/L. The presence of nucleic acids and nucleotides (more than 20%) inhibit the identification of the protein. In this case, the optical density of the same solution is measured at two wavelengths: 260 and 280 nm; the amount of protein X (mg/ml) is calculated using the Calcar formula:

X=1.45·D₂₈₀−0.74·D₂₆₀.

The mixture of oligopeptides and RNA obtained is boiled for 10 minutes; then the sediment of non-hydrolyzed biopolymers that has been created is separated by centrifuge at 5 g over 20 minutes. To the sedimentary liquid, fluorescein isorhonate is added at a ratio to the protein of 1/10000; the solution is left to stand at +50 C for five hours. Then solid succinic anhydride is added at a ratio to the protein concentration of 2:1. The reagent mixture obtained is used in the antibody fluorescing method. Standard bovine serum albumin conjugated with rhodamine is also used in the array.

Detection of infection by the H1N1 influenza virus. Bronchial secretions, nasal discharge smears, and blood are taken from patients in whom influenza is suspected. Each sample is resuspended in a 0.9% buffered solution of sodium chloride and centrifuged. The resuspension and centrifuging procedure is repeated three times to clean the cells of accompanying soluble components. The cell sediment is taken up with a micropipette and placed on a slide; with another piece of glass, the cell suspension is spread evenly across the slide. The smear is allowed to dry and is fixed with an acetone solution or with a Nikiforov mixture until the smear is desiccated. The peptide formula obtained in Example 1 is then placed on the dried smear and left to incubate at a temperature of 37° C. for 40 minutes in a humid chamber to keep the smear from desiccating. Then the smear is rinsed with a buffered 0.9% solution of sodium chloride, and a 0.1% solution of rhodamine-tagged bovine serum albumin is added; this is left to stand for 20 minutes in the incubator in a humid chamber. The tagged albumin processing is necessary in order to block extra cell epitopes not connected with the specific fluorescing peptides. Then the smear is removed from the incubator, rinsed with distilled water, and dried. Cells fluorescing green are detected under a fluorescent microscope. The cells infected by a virus fluoresce green; the healthy cells fluoresce red. If instead of a glass slide, a Gorjaev's chamber or fluorometric attachment is used, the percentage of cells infected with viruses can be counted.

To test the workability of the method, the test system developed was verified in a comparative test with the standardized, registered IIFM test system, the PCR test system, and the culture method. For detection purposes, tissue samples were obtained from hospital study patients aged 12 to 75 years, of both sexes during a flu epidemic.

As a control, the standard test system was used for the indirect immunofluorescent reaction (IIFM) for discovery of the H1N1 virus, made by the National Institute of Influenza Research of the Russian Academy of Medical Sciences (St. Petersburg, Russian Federation), the TaqMan (USA) revertase PCR diagnostic process, and discovery of the virus in ovo with its detection through the standardized hemagglutination method. The results are presented of the comparison between the standard IIFM and the patented method.

TABLE 1
Comparative Results of the Study of Patients from Two Groups:
With Clinical Symptoms of Influenza and a Control Group
without Clinical Symptoms of Influenza Undergoing Planned Study

| | Viral Antigen | | Antigen | | | |
|---|---|---|---|---|---|---|
| | Discovered | | Discovered | | | |
| | in Bronchial | | in Smear from | | Antigen Discovered in | |
| | Secretions | | Nasal Discharge | | Blood Leukocytes | |
| | (Total Patients/ | | (Total Patients/ | | (Total Patients/ | |
| | Discovered/%) | | Discovered/%) | | Discovered/%) | |
| | Experimental | Control | Experimental | Control | Experimental | Control |
| | Group (with | (without | Group (with | (without | Group (with | (without |
| | clinical | clinical | clinical | clinical | clinical | clinical |
| | symptoms of | symptoms | symptoms of | symptoms | symptoms of | symptoms |
| Method | flu) | of flu) | flu) | of flu) | flu) | of flu) |
| Substance Being | 180/107/59 | 40/4/10 | 180/102/57 | 40/2/5 | 180/110/61 | 40/4/10 |
| Patented | | | | | | |
| Control IIFM | 180/62/34 | 40/1/2.5 | 180/69/38 | 40/0/0 | 180/68/38 | 40/2/5 |
| Control | 180/102/57 | 40/6/15 | 180/100/55 | 40/5/12 | 180/100/55 | 40/4/10 |
| PCR | | | | | | |
| Cultured in ovo, | 180/106/59 | 40/3/7 | 180/101/56 | 40/1/2 | 180/110/61 | 40/4/10 |
| Detection of | | | | | | |
| Hemagglutination | | | | | | |

As may be seen in Table 1, the results of the analysis obtained from the developed method correlate most closely to the gold standard of virology: the culture method of viral detection and the PCR method in both groups: of patients with clinical symptoms of influenza and in practically healthy people. Thus, the proposed method has a high level of sensitivity and specificity; in accuracy it approaches the culture method of viral detection, which is a standard of viral diagnostics.

### EXAMPLE 3

### Selective Detection of DNA. Detection of Hepatitis B DNA Amplicon

Detection of HBV DNA. Analysis of the DNA of hepatitis B, qualitative detection of HBV DNA in the blood is the main criterion for arbitration, that characterizes activity of the viral process that can be used during infection by mutant forms of the virus, with immunosuppression (cancer patients, drug addicts, etc.) and to quantify the presence in the body of the disease agent. Quantitative characteristics of HBV DNA in clinical samples is important to assess the effectiveness of antiviral therapy. If the concentration of the virus is less than 105 copies/mL, the treatment forecast is favorable, but if this concentration is higher, it is necessary to apply other treatments.

Reducing the concentration of HBV DNA in the week after the start of treatment for no less than a third is a fast and precise parameter for predicting the effectiveness of therapy, leading to an early virologic response.

3.1. Synthesized and amplified are conservative DNA amplicon genome of HCV of 52 n.b. and flanked by the primers 5′-CAAAGC CACCCAAG-3′, 5′-GTTCAAGCCTCCAAGCTGTG-3′ in a standard polymerase chain reaction. The specificity of the primer and amplicon is shown in [KONG, De-Ming; SHEN, Han-Xi; MI, Huai-Feng. Detection of Hepatitis B Virus DNA by Duplex Scorpion. Primer-based PCR Assay. Chinese Journal of Chemistry, 2004, 22, 903 907].

As control are used amplicons of positive samples from the PCR test systems Vektor-Best Companies to determine the genome of Epstein-Barr virus (D-2198) and cytomegalovirus (D-1598). Virus genomes are studied in detail, and primers are offered for the first time in [Hess RD//J. Clin. Microbiol. 2004. V. 42. P. 3381-3387.].

3.2. Fragmentation and carboxylation. To 10 ml of the amplicon DNA concentration 10 mg/mL are added 2 U of DNA nuclease Tr and leave for 20 minutes, stirring at 70° C., the temperature then is raised to a boil and content is boiled for 10 minutes, stopping the reaction. After cooling solution to room temperature, 20 mg of sodium hydroxide are added and stirred until it is completely dissolved. To the resulting mixture of sodium salts of DNA oligonucleotides, 50 mg of dry succinic anhydride are added and stirred until it dissolves. Also added to the solution 2 mL 5*10-5 mg/ml of flyuorestseinizotiotsianat solution in ethanol and keep it at a temperature of 5° C. for 12 hours. The resulting reagent (I) is used to detect DNA in biological fluids of the hepatitis B virus.

3.3. Detection of viral genomes in biological fluids. Fluorescence intensity was obtained in a microquartz cuvette (16.40-F, Starna Brand, England) using a Shimadzu Model RF-540 spectrofluorometer (Kyoto, Japan). Vial is filled with 5 mL of biological fluid (no special handling and DNA extraction), also added are 5 ml of reagent (I). The mixture is stirred and allowed to stand for 5 minutes, and then centrifuged. Supernatant liquid is taken to another vial and then measured is the intensity of fluorescence at 490 nm relative to the diluted 2 times original reagent. In the presence of the viral genome in 100 copies of HBV DNA/ml and higher, fluorescence intensity of the solution drops by more than 30% (100 genomes of hepatitis B virus DNA in 1 mL of sample).

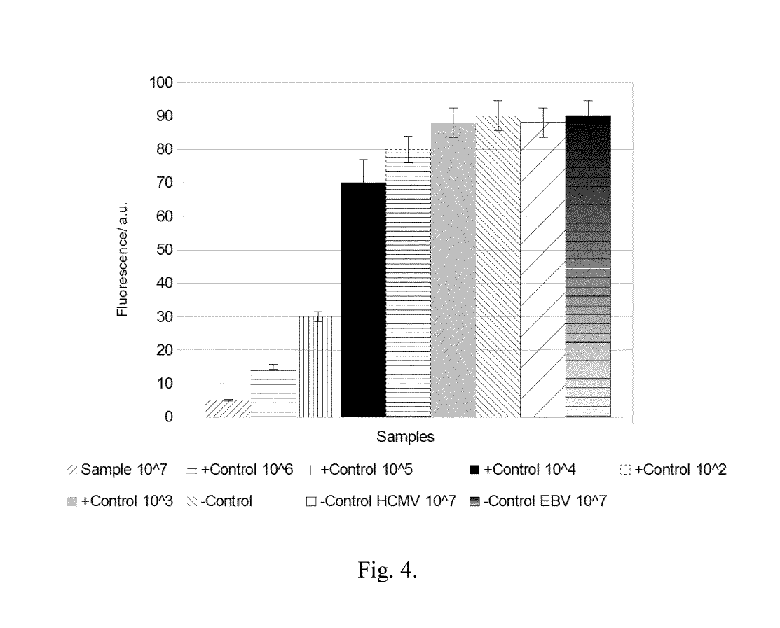

With no significant difference in fluorescence intensity between the sample vial and the vial with 2-fold diluted reagent (I) the absence of hepatitis B virus genome is indicated. In the positive control the amplicon source of hepatitis B in the amount of 106-102 copies of HBV/ml tenfold dilutions is used. The diagram, FIG. 4 is shows relationship between the fluorescence and the number of copies of genomes in the sample—i.e., inverse relationship—the less viral DNA is in the sample, the greater is the intensity of the fluorescence of the solution.

This diagram determines the number of copies of the genome of hepatitis B virus in the sample. If the sample contains DNA of hepatitis B virus the chain reaction of supramolecular insoluble structure self-assembly proceeds at the bottom of the tube and therefore in the solution the fluorescence intensity drops sharply due to reduction of the DNA fragments of oligonucleotides labeled with a fluorescent probe. A similar situation is observed in the positive control sample, and in a negative control sample fluorescence remains high. There was also no cross-reactions with non-specific amplicons of other viruses—cytomegalovirus and Epstein-Barr virus.

Advantages: there is no need in the procedure of polymerase chain reaction and in the amplification procedure, and, accordingly, —Taq and thermostats, the reaction is complete within 5-10 minutes at room temperature. To detect HBV genome need either an amplified whole genome of the hepatitis B virus, or hepatitis B virus amplicon, also pre-amplified.

### REFERENCES

1. Park E J, Lee K S, Lee K C, Na D H. Application of microchip CGE for the analysis of PEG-modified recombinant human granulocyte-colony stimulating factors. Electrophoresis. 2010 November;31(22):3771-4.
2. Glauner B. Separation and quantification of muropeptides with high-performance liquid chromatography. Anal Biochem. 1988 Aug. 1;172(2):451-64.
3. Szókán G, Kelemen G, Török A. High-performance liquid chromatography of isopeptides. J Chromatogr. 1986 Sep 24;366:283-92.
4. Graham, R.L., Groetschel M., and Lovász L., eds. (1996). Handbook of Combinatorics, Volumes 1 and 2. Elsevier (North-Holland), Amsterdam, and MIT Press, Cambridge, Mass. ISBN 0-262-07169-X.

1. A method for identification of a natural biopolymer in biological fluids and environmental objects, comprising:
enzymatic fragmentation of a sample of the natural biopolymer with formation of a mixture of oligomer fragments;
carboxylation of the mixture of oligomer fragments;
application of the carboxylated mixture of oligomer fragments as a reagent in a test system, the reagent selectively binds to the natural biopolymer.

2. The method of claim 1, wherein the natural biopolymer is an individual protein.

3. The method of claim 1, wherein the natural biopolymer is a mixture of proteins.

4. The method of claim 1, wherein the natural biopolymer is RNA.

5. The method of claim 1, wherein the natural biopolymer is DNA.

6. The method of claim 1, wherein the natural biopolymer is a mixture of proteins, RNA and DNA.

7. The method of claim 1, wherein the enzymatic fragmentation of the natural biopolymer is provided with nuclease and protease.

8. The method of claim 1, wherein the carboxylation is provided by acylation of the mixture of oligomer fragments with polycarboxylic acid anhydride.

9. The method of claim 1, wherein the carboxylation is provided by alkylation of the mixture of oligomer fragments with chlorine derivatives of organic adds.

10. The method of claim 8, wherein the polycarboxylic add anhydrides is succinic anhydride.

11. The method of claim 9, wherein the chlorine derivative of organic add is monochloroacetic acid.

12. The method of claim 1, wherein the test system uses a method of fluorescence analysis.

13. The method of claim 1, wherein the test system uses a method of agglutination.

14. The method of claim 1, wherein the test system uses an agar diffusion method.

15. The method of claim 1, wherein the test system uses a method of electrophoresis.

16. The method of claim 1, wherein the test system uses a method of chromatography on thin layers.
